(19) United States
(12) Patent Application Publication
(10) Pub. No.: US 2023/0043904 A1
(43) Pub. Date: Feb. 9, 2023

(54) INORGANIC NANOMATERIAL FOR CONTINUOUS FORMALDEHYDE REMOVAL AND PREPARATION METHOD THEREOF

(71) Applicant: Zhejiang Huade New Materials Co., Ltd., Hangzhou (CN)

(72) Inventors: Weidong WANG, Hangzhou (CN); Langsong SI, Hangzhou (CN); Jie MA, Hangzhou (CN)

(73) Assignee: Zhejiang Huade New Materials Co., Ltd., Hangzhou (CN)

(21) Appl. No.: 17/573,642

(22) Filed: Jan. 12, 2022

(30) Foreign Application Priority Data
Aug. 3, 2021 (CN) 202110885930.X

(51) Int. Cl. C09D 1/04; C08K 3/08; C09D 7/61; C09D 183/04; C08K 3/26; C08K 3/34; C08K 3/22

(52) U.S. Cl. CPC C09D 1/04; C08K 3/08; C09D 7/61; C09D 183/04; C08K 2003/265; C08K 3/34; C08K 2003/2241; C08K 2003/0818

(57) ABSTRACT

An inorganic nanomaterial for continuous formaldehyde removal includes the following components in part by mass: 20-30 parts of water, 0.1-0.3 parts of cellulose, 0.1-0.2 parts of a defoamer, 0.3-0.6 parts of a dispersant, 0.3-0.6 parts of a wetting agent, 20-25 parts of titanium dioxide, 5-10 parts of kaolin, 10-15 parts of heavy calcium, 30-40 parts of modified inorganic hybrid resin, 0.1-1 part of a film-forming additive, and 0.1-1 part of propylene glycol. After inorganic hybrid modification, an ammonia group is introduced, which can continuously and effectively decompose formaldehyde in the environment. A coating film not only has good anti-mildew, anti-algae, fire prevention, and heat insulation functions, but also has a continuous formaldehyde removal function. The formaldehyde removal efficiency is greater than 95%. The durability of formaldehyde purification effect is 90%.

### CROSS REFERENCE TO THE RELATED APPLICATIONS

This application is based upon and claims priority to Chinese Patent Application No. 202110885930.X, filed on Aug. 3, 2021, the entire contents of which are incorporated herein by reference.

### TECHNICAL FIELD

The present disclosure relates to the field of decorative materials for building interior decoration, and in particular to an inorganic nanomaterial for continuous formaldehyde removal and a preparation method thereof.

### BACKGROUND

With the rapid growth of China's economy, the construction industry has developed quickly in recent years. The interior and exterior wall architectural coatings industry in China is facing new development opportunities and challenges, and the market demand is steadily growing. Firstly, the development of urbanization has brought huge growth space to architectural coatings. Secondly, the upgrading of the old city is also a new market of architectural coatings. Especially with the rapid development of residential construction, people's pursuit of comfortable living conditions has greatly stimulated the promotion and application of various architectural coatings. In addition, the development of the architectural coatings has and will continue to receive strong support from the central to local governments at all levels. In recent years, the Ministry of Housing and Urban-Rural Development has held an architectural coatings development forum every year, and various localities have successively issued relevant policies and regulations to promote the application of the architectural coatings, which has created a good external environment for the development of China's architectural coatings industry.

In recent years, the central government has made great efforts to promote energy conservation and emission reduction. At the press conference of the National Development and Reform Commission in April 2021, it is stated that China strives to achieve carbon peaks by 2030 and carbon neutrality by 2060. It is a major strategic decision of China. In the architectural coatings, synthetic resin materials with traditional petroleum cracking as raw materials are binding substances having high energy consumption and high emission, which are not environmentally friendly and do not conform to the national carbon peak and carbon neutral policies. Therefore, seeking new binding substances in the architectural coatings industry has become the focus of industry development.

In ancient architectural engineering, aqueous solution and aqueous dispersion of alkali metal silicate were commonly used, and then pigments and fillers were added to obtain silicate and silica sol inorganic coatings, which have good water resistance, alkali resistance, pollution resistance, and weathering resistance. Based on this principle, the research on inorganic binding materials has become a hot spot in architectural coatings in recent years.

In terms of interior decoration, the development of decorative materials tends to lead to diversification, fashion, personalization, and most importantly, nontoxicity. Inorganic mineral coatings are developed as needed and come in time and are characterized by anti-mildew, fire prevention, and heat insulation functions.

### SUMMARY

An objective of the present disclosure is to prepare an inorganic environment-friendly interior wall coating for continuous and efficient formaldehyde removal with fire prevention, heat insulation, anti-mildew, and anti-algae functions, and to provide a preparation method with simple process and convenient production.

One of the technical solutions provided by the present disclosure is as follows:

An inorganic nanomaterial for continuous formaldehyde removal includes the following components in part by mass: 20-30 parts of water, 0.1-0.3 parts of cellulose, 0.1-0.2 parts of a defoamer, 0.3-0.6 parts of a dispersant, 0.3-0.6 parts of a wetting agent, 20-25 parts of titanium dioxide, 5-10 parts of kaolin, 10-15 parts of heavy calcium, 30-40 parts of modified inorganic hybrid resin, 0.1-1 part of a film-forming additive, and 0.1-1 part of propylene glycol.

For the modified inorganic hybrid resin, organic amine (—CH₂—NH₂) and organic silicone resin (—Si—O—Si—) may be added with an initiator at 120-180° C. to obtain amino organic silicone resin (—CH₂—NH—Si—O—), and then the amino organic silicone resin and inorganic resin may be added with an emulsifier at 80-120° C. to obtain inorganic hybrid resin. An ammonia group is introduced into the modified inorganic hybrid resin. The group can continuously and effectively react with formaldehyde in the environment, thereby continuously decomposing the formaldehyde in the environment.

The cellulose may be hydroxyethyl cellulose. The defoamer may be an organic silicone defoamer. The dispersant may be an ammonium salt dispersant. The wetting agent may be a non-ionic surfactant.

The titanium dioxide may be rutile titanium dioxide. The kaolin may be calcined kaolin. The heavy calcium may be heavy calcium carbonate. As a white pigment, the rutile type titanium dioxide has high dispersion, high weather resistance, high hiding power, and excellent stability. The calcined kaolin is made from hard kaolin after repeated grinding and high-temperature calcination, loses crystal water to form a fluffy porous flake-shaped structure, and has unique performance advantages such as high activity, high whiteness, high dispersion, and high hiding. The heavy calcium carbonate increases a product volume, reduces costs, improves processing performance, adjusts viscosity and rheological properties, improves product stability, and also improves physical properties such as heat resistance, extinction, wear resistance, flame retardancy, whiteness, and gloss.

The film-forming additive may be 2,2,4-trimethyl-1,3-pentanediol monoisobutyrate. The 2,2,4-trimethyl-1,3-pentanediol monoisobutyrate has good resin compatibility, viscosity, and low pollution when used in coatings, and the coating prepared with it as the film-forming additive has good leveling and sag resistance, and good color development.

A preparation method of an inorganic nanomaterial for continuous formaldehyde removal includes the following steps:
1) installing a dispersing stirring paddle in a reactor, and adding water, a defoamer, a dispersant, a wetting agent, and cellulose to the reactor for dispersion at a medium speed for 15-25 min to obtain a pulp;
2) increasing a rotational speed of the dispersing stirring paddle to a high speed, and slowly adding titanium dioxide, kaolin, and heavy calcium for dispersion for 20-30 min to prepare a slurry; and
3) reducing the rotational speed of the dispersing stirring paddle to a low speed, and slowly adding modified inorganic hybrid resin, a film-forming additive, and propylene glycol for uniform dispersion to prepare a finished inorganic coating for formaldehyde removal.

The high speed may refer to the rotational speed of the dispersing stirring paddle greater than 8,000 r/min.

The medium speed may refer to the rotational speed of the dispersing stirring paddle greater than 4,000-5,000 r/min.

The low speed may refer to the rotational speed of the dispersing stirring paddle less than 500 r/min.

The titanium dioxide, the kaolin, and heavy calcium powder may be added at a rate less than 25 kg/min, and the modified inorganic hybrid resin, the film-forming additive, and the propylene glycol may be added at a rate less than 500 ml/min.

The present disclosure has the following advantages:

For the modified inorganic hybrid resin, the organic amine and the organic silicone resin are added with the initiator to obtain the amino organic silicone resin, and then the amino organic silicone resin and the inorganic resin are added with the emulsifier to obtain the inorganic hybrid resin. In this way, the prepared inorganic coating not only has inorganic characteristics of inorganic amine retained, but also has the characteristics of good color persistence, strong adhesion, good water and alkali resistance, pollution resistance, good air permeability, and a grade A fire rating. After inorganic hybrid modification, pigments and fillers are added to form a continuous and dense coating film by applying the coating to a wall. The ammonia group is also introduced, which can continuously and effectively decompose the formaldehyde in the environment. The film not only has good anti-mildew, anti-algae, fire prevention, and heat insulation functions, but also has a continuous formaldehyde removal function. The formaldehyde removal efficiency is greater than 95%. The durability of formaldehyde purification effect is 90%. The nanomaterial is a healthy and environment-friendly decorative material for interior decoration with very wide application prospects. In addition, the inorganic nanomaterial provided by the present disclosure has a simple production process and can be mass produced on a large scale.

### DETAILED DESCRIPTION OF THE EMBODIMENTS

In order to enable those skilled in the art to better understand the solutions of the present disclosure, the technical solutions in the examples of the present disclosure will be clearly and completely described below. It is obvious that the described examples are only a part of, not all of, the examples, and based on the examples of the present disclosure, all other examples obtained by those of ordinary skill in the art without creative efforts fall within the protection scope of the present disclosure.

The following describes the present disclosure in detail with reference to specific implementations and examples.

The present disclosure uses modified inorganic hybrid resin as a film-forming substance, and uses rutile titanium dioxide, kaolin, and heavy calcium as pigments and fillers to prepare an inorganic interior decorative material for formaldehyde removal with good color durability, strong adhesion, good water and alkali resistance, pollution resistance, good air permeability, and a grade A fire rating, which just meet the needs of the market.

### EXAMPLE 1

An inorganic nanomaterial for continuous formaldehyde removal included the following components in part by mass: 22.5 parts of water, 0.2 parts of cellulose, 0.2 parts of a defoamer, 0.5 parts of a dispersant, 0.6 parts of a wetting agent, 25 parts of titanium dioxide, 10 parts of kaolin, 10 parts of heavy calcium, 30 parts of modified inorganic hybrid resin, 0.6 parts of a film-forming additive, and 0.4 parts of propylene glycol.

A preparation method of the above inorganic nanomaterial for continuous formaldehyde removal included the following steps.
1) A dispersing stirring paddle was installed in a reactor, and water, the defoamer, the dispersant, the wetting agent, and the cellulose were added to the reactor for dispersion at a medium speed for 20 min to obtain a pulp, wherein a rotational speed of the dispersing stirring paddle in the reactor is greater than 4,000-5,000 r/min.
2) The rotational speed of the dispersing stirring paddle was increased, and the titanium dioxide, the kaolin, and the heavy calcium were slowly added for dispersion at a high speed for 30 min to prepare a slurry, wherein the rotational speed of the dispersing stirring paddle in the reactor is greater than 8,000 r/min.
3) The rotational speed of the dispersing stirring paddle was reduced to a low speed, and the modified inorganic hybrid resin, the film-forming additive, and the propylene glycol were slowly added for dispersion at the low speed to prepare a finished inorganic coating for formaldehyde removal, wherein the rotational speed of the dispersing stirring paddle in the reactor is not greater than 500 r/min.

### EXAMPLE 2

An inorganic nanomaterial for continuous formaldehyde removal included the following components in part by mass: 25 parts of water, 0.2 parts of cellulose, 0.2 parts of a defoamer, 0.5 parts of a dispersant, 0.6 parts of a wetting agent, 20 parts of titanium dioxide, 7.5 parts of kaolin, 10 parts of heavy calcium, 35 parts of modified inorganic hybrid resin, 0.6 parts of a film-forming additive, and 0.4 parts of propylene glycol.

A preparation method of the above inorganic nanomaterial for continuous formaldehyde removal included the following steps.
1) A dispersing stirring paddle was installed in a reactor, and water, the defoamer, the dispersant, the wetting agent, and the cellulose were added to the reactor for dispersion at a medium speed for 20 min to obtain a pulp, wherein a rotational speed of the dispersing stirring paddle in the reactor is greater than 4,000-5,000 r/min.
2) The rotational speed of the dispersing stirring paddle was increased, and the titanium dioxide, the kaolin, and the heavy calcium were slowly added for dispersion at a high speed for 30 min to prepare a slurry, wherein the rotational speed of the dispersing stirring paddle in the reactor is greater than 8,000 r/min.
3) The rotational speed of the dispersing stirring paddle was reduced to a low speed, and the modified inorganic hybrid resin, the film-forming additive, and the propylene glycol were slowly added for dispersion at the low speed to prepare a finished inorganic coating for formaldehyde removal, wherein the rotational speed of the dispersing stirring paddle in the reactor is not greater than 500 r/min.

### EXAMPLE 3

An inorganic nanomaterial for continuous formaldehyde removal included the following components in part by mass: 30 parts of water, 0.2 parts of cellulose, 0.2 parts of a defoamer, 0.5 parts of a dispersant, 0.6 parts of a wetting agent, 22 parts of titanium dioxide, 5 parts of kaolin, 15 parts of heavy calcium, 40 parts of modified inorganic hybrid resin, 0.6 parts of a film-forming additive, and 0.4 parts of propylene glycol.

A preparation method of the above inorganic nanomaterial for continuous formaldehyde removal included the following steps.
4) A dispersing stirring paddle was installed in a reactor, and water, the defoamer, the dispersant, the wetting agent, and the cellulose were added to the reactor for dispersion at a medium speed for 20 min to obtain a pulp, wherein a rotational speed of the dispersing stirring paddle in the reactor is greater than 4,000-5,000 r/min.
5) The rotational speed of the dispersing stirring paddle was increased, and the titanium dioxide, the kaolin, and the heavy calcium were slowly added for dispersion at a high speed for 30 min to prepare a slurry, wherein the rotational speed of the dispersing stirring paddle in the reactor is greater than 8,000 r/min.
6) The rotational speed of the dispersing stirring paddle was reduced to a low speed, and the modified inorganic hybrid resin, the film-forming additive, and the propylene glycol were slowly added for dispersion at the low speed to prepare a finished inorganic coating for formaldehyde removal, wherein the rotational speed of the dispersing stirring paddle in the reactor is not greater than 500 r/min.

Experimental data of the inorganic nanomaterial for continuous formaldehyde removal prepared by the present disclosure far exceeds the standard of superior products and interior wall finishing paint of GB/T9756-2018 “Synthetic resin emulsion coatings for interior wall” and the standard requirements of interior wall coating gloss (60°≤10° finishing paint) of HJ2537-2014 “Technical requirement for environmental labeling products-Water based Coatings”.

| Serial | | Technical | Test results | | | |
|---|---|---|---|---|---|---|
| No. | Test item | requirements | Example 1 | Example 2 | Example 3 | Conclusion |
| 1 | State in a | No clumps, and | No clumps, and | No clumps, and | No clumps, and | Meet |
| | container | a uniform state | a uniform state | a uniform state | a uniform state | requirements |
| | | after stirring | after stirring | after stirring | after stirring | |
| 2 | Application | Without | Without | Without | Without | Meet |
| | property | obstacle in the | obstacle in the | obstacle in the | obstacle in the | requirements |
| | | second pass of | second pass of | second pass of | second pass of | |
| | | brush coating | brush coating | brush coating | brush coating | |
| 3 | Low- | Not | Not | Not | Not | Meet |
| | temperature | deteriorated | deteriorated | deteriorated | deteriorated | requirements |
| | stability | | | | | |
| | (3 cycles) | | | | | |
| 4 | Alkali | No | No | No | No | Meet |
| | resistance | abnormality | abnormality | abnormality | abnormality | requirements |
| | (96 h) | | | | | |
| 5 | Scrubbing | ≥6,000 | 30,000 times, | 30,000 times, | 30,000 times, | Meet |
| | resistance/ | | a paint | a paint | a paint | requirements |
| | times | | film is | film is | film is | |
| | | | damaged | damaged | damaged | |
| 6 | Mildew | Grade 0 | Grade 0 | Grade 0 | Grade 0 | Meet |
| | resistance | (no obvious | (no obvious | (no obvious | (no obvious | requirements |
| | of paint film | mildew at | mildew at | mildew at | mildew at | |
| | (28 days) | 50 times | 50 times | 50 times | 50 times | |
| | | magnification) | magnification) | magnification) | magnification) | |
| 7 | Combustion | Grade A | A (A2) | A (A2) | A (A2) | Meet |
| | performance | | | | | requirements |
| | grade | | | | | |
| 8 | VOC | ≤80 | 5 | 8 | 4 | Meet |
| | content, g/L | | | | | requirements |
| 9 | Total | ≤100 | Not | Not | Not | Meet |
| | content of | | detected | Detected | Detected | requirements |
| | benzene | | | | | |
| | series/(mg/Kg) | | | | | |
| 10 | Content of | ≤50 | Not | Not | Not | Meet |
| | formaldehyde/ | | Detected | Detected | Detected | requirements |
| | (mg/Kg) | | | | | |
| 11 | Formaldehyde | ≥75 | 95% | 96% | 96% | Meet |
| | purification | | | | | requirements |
| | efficiency, % | | | | | |
| 12 | Durability of | ≥60 | 90% | 91% | 90% | Meet |
| | formaldehyde | | | | | requirements |
| | purification | | | | | |
| | effect, % | | | | | |

The inorganic nanomaterial for continuous formaldehyde removal of examples of the present disclosure has a resistance to scrubbing up to 30,000 times, no mildew in 28 days, a grade A fire rating, extremely low VOC content, and little benzene series and formaldehyde. Furthermore, an ammonia group is introduced to the modified inorganic hybrid resin, which can continuously and effectively decompose the formaldehyde in the environment. The formaldehyde purification efficiency is greater than 95%. The durability of formaldehyde purification effect is 90%. The nanomaterial is a healthy and environment-friendly decorative material for interior decoration with very wide application prospects.

Although the examples of the present disclosure have been illustrated, it should be understood that those of ordinary skill in the art may still make various changes, modifications, replacements and variations to the above examples without departing from the principle and spirit of the present disclosure, and the scope of the present disclosure is limited by the claims and equivalents thereof.

What is claimed is:

1. An inorganic nanomaterial for continuous formaldehyde removal, comprising the following components in part by mass: 20-30 parts of water, 0.1-0.3 parts of cellulose, 0.1-0.2 parts of a defoamer, 0.3-0.6 parts of a dispersant, 0.3-0.6 parts of a wetting agent, 20-25 parts of titanium dioxide, 5-10 parts of kaolin, 10-15 parts of heavy calcium, 30-40 parts of modified inorganic hybrid resin, 0.1-1 part of a film-forming additive, and 0.1-1 part of propylene glycol.

2. The inorganic nanomaterial according to claim 1, wherein organic amine and organic silicone resin are added with an initiator at 120-180° C. to obtain amino organic silicone resin, and then the amino organic silicone resin and inorganic resin are added with an emulsifier at 80-120° C. to obtain the modified inorganic hybrid resin.

3. The inorganic nanomaterial according to claim 1, wherein the cellulose is hydroxyethyl cellulose; the defoamer is an organic silicone defoamer; the dispersant is an ammonium salt dispersant; and the wetting agent is a non-ionic surfactant.

4. The inorganic nanomaterial according to claim 1, wherein the titanium dioxide is rutile titanium dioxide; the kaolin is calcined kaolin; and the heavy calcium is heavy calcium carbonate.

5. The inorganic nanomaterial according to claim 1, wherein the film-forming additive is 2,2,4-trimethyl-1,3-pentanediol monoisobutyrate.

6. A preparation method of an inorganic nanomaterial for continuous formaldehyde removal, comprising the following steps:
1) installing a dispersing stirring paddle in a reactor, and adding water, a defoamer, a dispersant, a wetting agent, and cellulose to the reactor for dispersion at a medium speed for 15-25 min to obtain a pulp;
2) increasing a rotational speed of the dispersing stirring paddle to a high speed, and slowly adding titanium dioxide, kaolin, and heavy calcium for dispersion for 20-30 min to prepare a slurry; and
3) reducing the rotational speed of the dispersing stirring paddle to a low speed, and slowly adding modified inorganic hybrid resin, a film-forming additive, and propylene glycol for uniform dispersion to prepare a finished inorganic coating for formaldehyde removal.

7. The preparation method according to claim 6, wherein the high speed indicates the rotational speed of the dispersing stirring paddle is greater than 8,000 r/min.

8. The preparation method according to claim 6, wherein the medium speed indicates the rotational speed of the dispersing stirring paddle is 4,000-5,000 r/min.

9. The preparation method according to claim 6, wherein the low speed indicates the rotational speed of the dispersing stirring paddle is not greater than 500 r/min.

10. The preparation method according to claim 6, wherein the titanium dioxide, the kaolin, and heavy calcium powder are added at a rate less than 25 kg/min, and the modified inorganic hybrid resin, the film-forming additive, and the propylene glycol are added at a rate less than 500 ml/min.
